(19) United States
(12) Patent Application Publication
(10) Pub. No.: US 2021/0304312 A1
(43) Pub. Date: Sep. 30, 2021

(54) SYSTEM AND METHOD FOR PROCESSING A CLAIM FOR RESIDENTIAL LOSS

(71) Applicant: STATE FARM MUTUAL AUTOMOBILE INSURANCE COMPANY, Bloomington, IL (US)

(72) Inventor: Bryan R. Nussbaum, Bloomington, IL (US)

(21) Appl. No.: 15/052,591

(22) Filed: Feb. 24, 2016

(51) Int. Cl. G06Q 40/08

(52) U.S. Cl. CPC G06Q 40/08

(57) ABSTRACT

A computer-implemented method for processing a claim for a loss associated with a residence is presented. An indication of the loss may be received, including an indication that the loss is a verified loss as determined from analyzing data associated with the residence with respect to additional data associated with residential loss. The data associated with the residence may include data from a monitoring device(s). The additional data associated with residential loss may be provided from a party that facilitates a determination of whether the loss is a verified loss. An attribute(s) of the claim for the loss may be identified based on the data associated with the residence and/or further data. The claim may be caused to be processed based on receiving the indication that the loss is a verified loss and on the attribute(s). Data regarding the claim processing may be generated to provide to an insured party.

### FIELD OF THE DISCLOSURE

The present disclosure generally relates to loss associated with a residence and, more particularly, to a system and method for processing a claim for a loss associated with a residence.

### BACKGROUND

As residential monitoring increases for purposes of providing insurance for a residence and facilitating responsiveness to residential losses from police departments, fire departments, and other entities, insurance providers and such responding entities are susceptible to receiving an increased number of claims of residential loss. Not all claims, such as those initiated based on reliance upon residential monitoring devices, are actually legitimate claims that should be processed by an insurance provider and/or responded to by an appropriate department or other entity. Monitoring devices may cause “false alarms” or claims to be produced based on factors such as settings of the monitoring devices, which may have been previously determined by a homeowner. Additionally, a homeowner reporting a claim for a residential loss may misinterpret data generated by a monitoring device or devices and thus contribute to a “false alarm” or claim that should not be processed.

As the number of potential claims increase, some types of entities, such as police departments and fire departments, have implemented and will likely continue to implement measures intended to ensure that losses reported to them are legitimate. An insurance provider for a residence will have a similar interest in the deployment of resources that will assist in avoiding the initiation of processing of claims that are not actually legitimate claims of loss.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one embodiment, a computer-implemented method for processing a claim for a loss associated with a residence may be provided. The method may include receiving, using one or more processors of a claim processing subsystem of a residential claim system, via a computer network, an indication of the loss associated with the residence, the received indication including an indication from a loss verification subsystem of the residential claim system that the loss associated with the residence is a verified loss associated with the residence, the indication that the loss associated with the residence is a verified loss being determined from an analysis by the loss verification subsystem of data associated with the residence with respect to additional data associated with residential loss, the data associated with the residence including data from at least one monitoring device associated with the residence, the additional data associated with residential loss being provided from a party that facilitates a determination of whether the loss associated with the residence is a verified loss. The method may also include identifying, using the one or more processors, at least one attribute of the claim for the loss associated with the residence based on at least one of the data associated with the residence or further data. The method may additionally include causing, using the one or more processors, the claim processing subsystem to process the claim for the loss associated with the residence based on receiving the indication from the loss verification subsystem that the loss associated with the residence is a verified loss and based on the at least one attribute of the claim for the loss associated with the residence. The method may further include generating, using the one or more processors, data regarding the processing of the claim for the loss associated with the residence to provide, via the computer network, to an insured party associated with the residence.

In another embodiment, a computing system for processing a claim for a loss associated with a residence may be provided. The computing system may include one or more processors and one or more memories coupled to the one or more processors. The one or more memories may include non-transitory computer executable instructions stored therein that, when executed by the one or more processors, cause the one or more processors to: (i) receive an indication of the loss associated with the residence, the received indication including an indication from a loss verification subsystem of a residential claim system that the loss associated with the residence is a verified loss associated with the residence, the indication that the loss associated with the residence is a verified loss being determined from an analysis by the loss verification subsystem of data associated with the residence with respect to additional data associated with residential loss, the data associated with the residence including data from at least one monitoring device associated with the residence, the additional data associated with residential loss being provided from a party that facilitates a determination of whether the loss associated with the residence is a verified loss; (ii) identify at least one attribute of the claim for the loss associated with the residence based on at least one of the data associated with the residence or further data; (iii) cause a claim processing subsystem of the residential claim system to process the claim for the loss associated with the residence based on receiving the indication from the loss verification subsystem that the loss associated with the residence is a verified loss and based on the at least one attribute of the claim for the loss associated with the residence; and (iv) generate data regarding the processing of the claim for the loss associated with the residence to provide to an insured party associated with the residence.

In yet another embodiment, a computer readable storage medium may be provided that includes non-transitory computer readable instructions stored thereon for processing a claim for a loss associated with a residence. The instructions, when executed on one or more processors, may cause the one or more processors to: (i) receive an indication of the loss associated with the residence, the received indication including an indication from a loss verification subsystem of a residential claim system that the loss associated with the residence is a verified loss associated with the residence, the indication that the loss associated with the residence is a verified loss being determined from an analysis by the loss verification subsystem of data associated with the residence with respect to additional data associated with residential loss, the data associated with the residence including data from at least one monitoring device associated with the residence, the additional data associated with residential loss being provided from a party that facilitates a determination of whether the loss associated with the residence is a verified loss; (ii) identify at least one attribute of the claim for the loss associated with the residence based on at least one of the data associated with the residence or further data; (iii) cause a claim processing subsystem of the residential claim system to process the claim for the loss associated with the residence based on receiving the indication from the loss verification subsystem that the loss associated with the residence is a verified loss and based on the at least one attribute of the claim for the loss associated with the residence; and (iv) generate data regarding the processing of the claim for the loss associated with the residence to provide to an insured party associated with the residence.

### BRIEF DESCRIPTION OF THE DRAWINGS

The figures described below depict various aspects of the system and methods disclosed herein. It should be understood that each figure depicts an embodiment of a particular aspect of the disclosed system and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 is a functional block diagram of an example residential claim system for processing a claim for a loss associated with a residence;

FIG. 2 illustrates an example implementation of a computing device that may be used in implementing various devices of the example system of FIG. 1;

FIG. 3 is a flow chart illustrating an example method for processing a claim for a loss associated with a residence;

FIG. 4 is a flow chart illustrating another example method for processing a claim for a loss associated with a residence;

FIG. 5 is a flow chart illustrating an example method for determining an indication of whether a loss associated with a residence is a verified loss;

FIG. 6 is a flow chart illustrating another example method for determining an indication of whether a loss associated with a residence is a verified loss;

FIG. 7 is a flow chart illustrating an example method for using data indicative of a device and/or material at a location in a residence in processing a claim for a loss;

FIG. 8 is a flow chart illustrating an example method for enhanced verification of loss; and

FIG. 9 is a flow chart illustrating an example method for sending an inquiry for data to an insured party associated with a residence.

The figures depict various aspects of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

Although the following text sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. §112(f).

### I. Example Indication of a Verified Loss Associated with a Residence for Processing a Claim for Residential Loss

The present embodiments relate to, inter alia, a system and method for processing a claim for a loss associated with a residence. Processing of the claim may be performed by an insurance provider, and more particularly may be performed by an insurance provider using a claim processing subsystem as described below. The loss associated with the residence may be, for example, a water loss associated with one or more of flooding, surface water, backed-up water, a burst pipe, etc. In another example, the loss associated with the residence may be a fire-related loss, such as damage to the residence caused by a fire in or near the residence. In yet another example, the loss associated with the residence may be a smoke-related loss, such as damage to walls, floors, etc. of the residence caused by smoke or, for example, damage to items within the residence caused by smoke. In still another example, the loss associated with the residence may be burglary-related and may thus relate to loss of property stolen from in or near the residence (e.g., from a garage, porch, or yard). It will be appreciated from the teaching and disclosure herein that multiple losses associated with the residence may occur in connection with a single event or multiple events, and that claims for such multiple losses associated with the residence may be processed concurrently or separately as needed or desired.

More particularly, embodiments described herein relate to a system and method for processing a claim for a loss associated with a residence that, generally speaking, allow receipt at a loss verification subsystem of data associated with the residence that is indicative of a loss, including data from a monitoring device or devices associated with the residence. The processing of the claim for the loss associated with the residence may also include receiving, at a loss verification subsystem, additional data associated with residential loss that may be provided by a party that facilitates a determination of whether the loss associated with the residence is a verified loss. The party that facilitates such a determination may be, for example, one or more of a provider (e.g., manufacturer, distributor, reseller, etc.) of a device(s) such as the aforementioned monitoring device(s) associated with the residence, an insured party associated with the residence, an insurance provider that insures the residence, etc. It will be appreciated in light of the teaching and disclosure herein that the party that facilitates such a determination may facilitate such a determination by way of, for example, providing the aforementioned monitoring device(s) and/or the loss verification subsystem such that the monitoring device(s) and/or the loss verification subsystem store and/or retrieve and use the additional data associated with residential loss to determine whether a loss is a verified loss, as further described herein. Additionally or alternatively, the party that facilitates the determination of whether the loss associated with the residence is a verified loss may be considered to facilitate such a determination because the party coordinates (e.g., enables or allows) such a determination by way of providing (e.g., directly providing and/or providing access to) the additional data associated with residential loss (e.g., by way of such additional data associated with residential loss being data stored by and/or retrieved/retrievable by the monitoring device(s) and/or the loss verification subsystem). In another example, the party that facilitates such a determination of whether the loss associated with the residence is a verified loss may facilitate such a determination by confirming or verifying upon inspection (e.g., in person, via a remote computing device, etc.) that the loss is a verified loss, and thus the additional data associated with residential loss in this example may be or may include such a confirmation or verification.

The data associated with the residence may be analyzed with respect to the additional data associated with residential loss in order to make the aforementioned determination of whether the loss associated with the residence is a verified loss, and thereby determine an indication of whether the loss is a verified loss. Such an indication may in turn be used to not only satisfy requirements of some police and fire departments, as described above, but also may be used to improve claim processing efficiency. For example, in some embodiments, the loss verification subsystem may cause the aforementioned claim processing subsystem to process a claim for a loss associated with the residence when the determined indication is an indication that the loss is a verified loss.

In some embodiments, an insurance provider, for example, may facilitate an additional determination of whether the loss associated with the residence is a verified loss by comparing data indicative of a loss determined to be a verified loss to previous insurance claim data. This comparison may be performed in order to detect fraudulent and/or “false positive” situations where, for example, a loss previously determined to be a verified loss is not actually a legitimate loss and is not to be treated and processed as a verified loss.

By providing a system and method that allows receipt of data associated with a residence and indicative of a loss, and receipt of additional data associated with residential loss provided or otherwise made available by a party (e.g., insured party; insurance provider; manufacturer, distributor, or reseller associated with the monitoring device(s); etc.) that facilitates a determination of whether the loss associated with the residence is a verified loss, various advantages are achieved. For example, the use of such additional data associated with residential loss improves upon existing computerized techniques relating to reporting and processing of insurance claims by basing verification of a claim of loss on data provided by the party that facilitates the determination of whether the loss associated with the residence is a verified loss. As further described below, the additional data associated with residential loss provided by the party that facilitates the determination of whether the loss associated with the residence is a verified loss may include data that indicates one or more conditions to be satisfied in order for the data that is associated with the residence and indicative of a loss to be indicative of a verified loss. For example, in the context of a water loss, the additional data associated with residential loss provided by the party that facilitates the determination of whether the loss associated with the residence is a verified loss may indicate one or more conditions that, when met by the outputs of a flood sensor and a temperature sensor, indicate a verified loss, e.g., a verified loss due to flooding. By using such additional data provided by a party that facilitates the determination of whether the loss associated with the residence is a verified loss as described herein, the accuracy of an overall system including the residence and a claim processing subsystem in processing only legitimate claims may be fundamentally improved. Other advantages will be recognized by one of ordinary skill in the art in light of the teaching and disclosure herein.

### II. Example System and Related Functionality

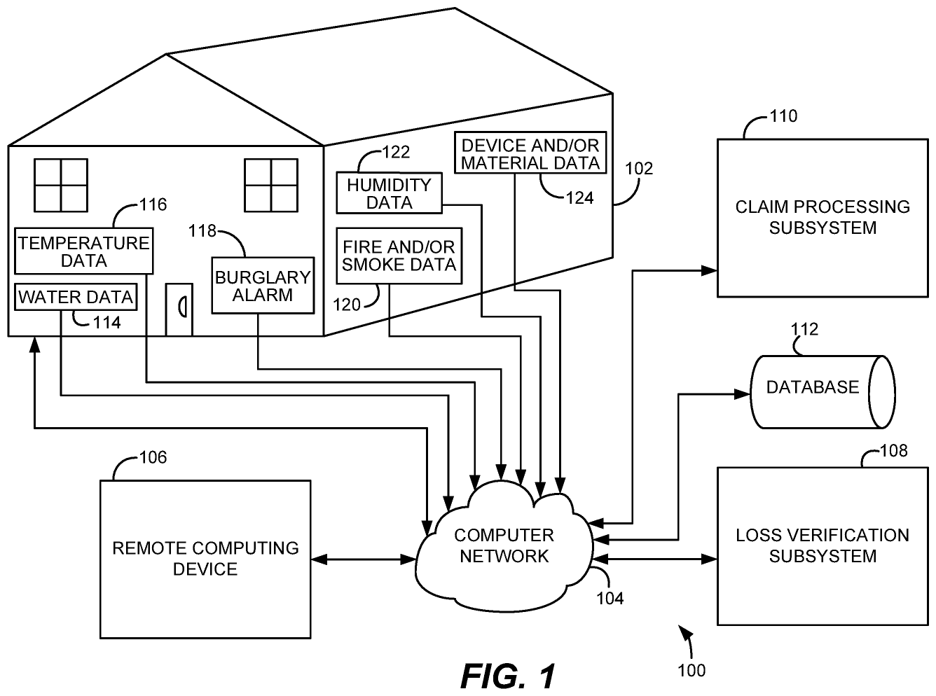

FIG. 1 illustrates an example residential claim system 100 for processing a claim for a loss associated with a residence. The example residential claim system 100 may include a residence 102, a computer network 104, a remote computing device 106, a loss verification subsystem 108, a claim processing subsystem 110, and a database 112 or other data storage mechanism (e.g., one or more hard disk drives, optical storage drives, solid state storage devices, etc.). As in other examples shown and described herein, singular instances of various elements may be shown as such for ease of illustration and explanation. Thus, for example, the example residential claim system 100 may include a number of residences 102 that are insured by an insurance provider, and any suitable number of remote computing devices 106, loss verification subsystems 108, claim processing subsystems 110, and databases 112.

The residence 102 may include at least one monitoring device. For example, as shown in FIG. 1, the residence 102 may include a water data device (e.g., flood sensor) 114; a temperature data device (e.g., temperature sensor) 116; a burglary alarm device (and/or home security system, for example) 118; a fire and/or smoke data device (e.g., fire alarm, smoke detector, etc.) 120; and a humidity data device (e.g., humidity sensor) 122. As further described below, the residence 102 may also include a device and/or material data source 124. The device and/or material data source 124 may provide data indicative of at least one location in or otherwise associated with (e.g., on a porch, in a garage, etc.) the residence 102 and may also provide data indicative of at least one of at least one device (e.g., an item of personal property) at the at least one location or at least one material (e.g., a type of building material used in the construction of the residence 102) at the at least one location. In this manner, an inventory of the residence 102 may be provided to the degree to which data from the device and/or material data source 124 is available, and this inventory may be used in claim processing as further described below. In other embodiments, the device and/or material data source 124 may not be included in the residence 102. Additionally or alternatively, in some embodiments, the data provided by the device and/or material data source 124 may have been previously received by the insurance provider and may thus be stored in, for example, a non-transitory computer-readable storage medium or media of the claim processing subsystem 110 or in the database 112, for example. As with other elements of the example residential claim system 100, a singular instance of each of the devices 114-122 and the device and/or material data source 124 is shown for ease of illustration and explanation, but any suitable number of any of the elements 114-124, and/or any other suitable elements for data monitoring and/or providing an inventory of the residence 102, may be implemented.

Each of the residence 102, the aforementioned components that are shown as being located therein in the example of FIG. 1, the remote computing device 106, the loss verification subsystem 108, the claim processing subsystem 110, and the database 112 may be communicatively coupled with the computer network 104. In other embodiments, various ones of the devices, subsystems, and other elements of the example residential claim system 100 may be communicatively coupled to one another in a manner other than via the computer network 104. By way of example, the loss verification subsystem 108 may be directly coupled to the residence 102 and, in one more particular example, each of the devices 114-122. As just one further example, additionally or alternatively, the loss verification subsystem 108 may be directly coupled to the claim processing subsystem 110 through a dedicated wired or wireless link.

The computer network 104 may be a computer network of the insurance provider (e.g., provided or used by the insurance provider, or communications over which the insurance provider otherwise controls or facilitates at least in part). In various embodiments, as further described below, processors of the remote computing device 106, the loss verification subsystem 108, and the claim processing subsystem 110 may execute instructions to transmit data to, receive data from, or otherwise communicate with one another, the database 112, and/or the residence 102, such as via the computer network 104. The computer network 104 may be or may include a network such as the Internet and/or any other type of suitable network (e.g., a local area network (LAN), a metropolitan area network (MAN), a wide area network (WAN), a mobile network, a wired or wireless network, a private network, a virtual private network, etc.). The computer network 104 may also or alternatively be or include one or more cellular networks such as code division multiple access (CDMA) network, GSM (Global System for Mobile Communications) network, WiMAX (Worldwide Interoperability for Microwave Access) network, Long Term Evolution (LTE) network, etc.

As further described below, the loss verification subsystem 108 and the claim processing subsystem 110, as well as the remote computing device 106, the database 112, the various devices 114-122, and the device and/or material data source 124, may be used in verification of an indicated loss associated with the residence 102 (e.g., using the loss verification subsystem 108 and data received thereby and/or available therein) and claim processing for the verified loss (e.g., using the claim processing subsystem 110 and data received thereby). The remote computing device 106, as further described below, may be used by an insured party associated with the residence 102 (e.g., homeowner) or another party to provide data used in, for example, the claim processing. The remote computing device 106, and each computing device referred to herein, may be any suitable computing device, such as but not limited to a desktop computer, a laptop computer, a mobile phone such as a smart phone, a tablet, a phablet, smart glasses, other wearable computing device(s), etc. With reference to the discussion above, the verification of the loss and the claim processing as provided by the example residential claim system 100 improve upon existing computerized techniques for claim processing by, for example, verifying a loss based on data provided by a party that facilitates a determination of whether the loss associated with the residence 102 is a verified loss and processing the claim when the claim is for a verified loss. In this manner, “false alarms” or claims that are otherwise not legitimate may be avoided.

### III. Example Operation of Remote Computing Device, Loss Verification Subsystem, and Claim Processing Subsystem

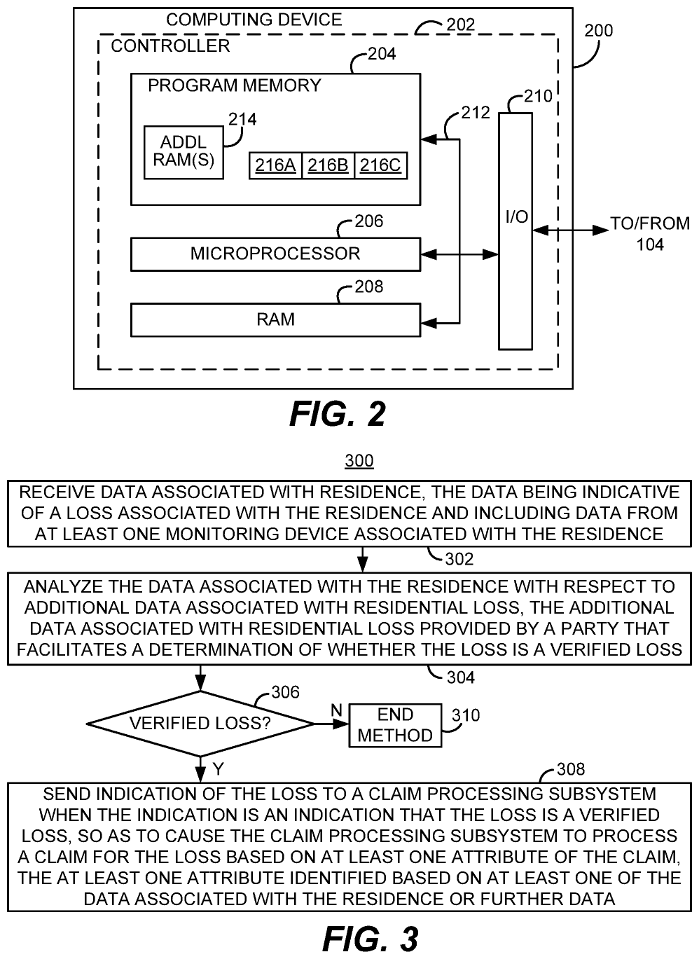

FIG. 2 illustrates an example computing device 200 and components thereof that may be used in implementing, for example, the remote computing device 106, the loss verification subsystem 108, and/or the claim processing subsystem 110. The loss verification subsystem 108 and the claim processing subsystem 110 are referred to herein as “subsystems” because in various embodiments, these components will each have multiple computing devices, such as multiple servers, and will be physically separate within the example residential claim system 100. For example, the loss verification subsystem 108 may be located at the residence 102 or at a location associated with the residence 102 and, in some examples, other residences similar to the residence 102. Multiple loss verification subsystems similar to the loss verification subsystem 108 may be implemented with respect to a number of residences, if desired. The loss verification subsystem 108 may be provided, used, implemented, operated, controlled, and/or facilitated by, for example, an insured party; an insurance provider; a manufacturer, distributor, reseller, etc. of a monitoring device(s) such as those described above; and/or any other suitable party or parties so that a loss(es) associated with the residence 102 is determined to be a verified loss(es) or not to be a verified loss(es) as described herein. The claim processing subsystem 110 may be provided, used, implemented, operated, controlled, and/or facilitated by, for example, an insurance provider and/or any other suitable party or parties so that a claim(s) for a verified loss(es) is/are processed as described herein.

The loss verification subsystem 108 and the claim processing subsystem 110 may include multiple computing devices that each have components the same as or similar to the components described with respect to the example computing device 200. Additionally, each of the loss verification subsystem 108 and the claim processing subsystem 110 may be referred to herein as a “system” or “computing system” or the like because each of the loss verification subsystem 108 and the claim processing subsystem 110 may have such multiple computing devices. Conversely, while the remote computing device 106 is shown and described as a single computing device, with reference to the discussion above, multiple instances of the remote computing device 106 may be implemented if desired. Such multiple instances of the remote computing device 106 may each have components that are the same as or similar to the components described with respect to the example computing device 200, for example.

Additionally, in other embodiments, the loss verification subsystem 108 and the claim processing subsystem 110 may not be physically distinct. For example, the loss verification subsystem 108 and the claim processing subsystem 110 may overlap in structure and/or operation. In some embodiments (not shown herein), one of the loss verification subsystem 108 or the claim processing subsystem 110 may include the other of the claim processing subsystem 110 or the loss verification subsystem 108. It will be understood that in such embodiments, among other embodiments, some or all communication between the loss verification subsystem 108 and the claim processing subsystem 110 described herein as being, in some examples, via the computer network 104, need not be via the computer network 104.

In any event, the example computing device 200 may include a controller 202. The controller 202 may include a program memory 204, a microcontroller or a microprocessor 206, a random-access memory (RAM) 208, and an input/output (I/O) circuit 210, all of which may be interconnected via an address/data bus 212. The program memory 204 may store computer-executable instructions, which may be executed by the microprocessor 206.

It should be appreciated that although FIG. 2 depicts only one microprocessor 206, the controller 202 may include multiple microprocessors 206. Similarly, the program memory 204 of the controller 202 may include additional RAM(s) 214 and multiple program memories 216A, 216B and 216C (or any suitable number of multiple program memories) storing one or more corresponding modules, routines, and/or instructions, etc. according to the particular configuration of the controller 202 and the computing device 200. Such modules, routines, and/or instructions, etc. may be used in performing various operations for processing a claim for a loss associated with a residence, such as example operations for processing a verified loss associated with the residence 102 that are described below as being performed by the loss verification subsystem 108 and/or the claim processing subsystem 110, for example. Additionally, although FIG. 2 depicts the I/O circuit 210 as a single block, the I/O circuit 210 may include a number of different types of I/O circuits (not depicted). The RAM(s) 208, 214 and the program memory/memories 216A, 216B and 216C may be implemented in any known form of non-transitory computer readable storage media, including but not limited to semiconductor memories, magnetically readable memories, and/or optically readable memories. It should also be appreciated that the example computing device 200, and thus any of the remote computing device 106, the loss verification subsystem 108, and/or the claim processing subsystem 110 may include additional, fewer, or alternate components.

### IV. Example Methods for Processing a Claim for a Loss Associated with a Residence

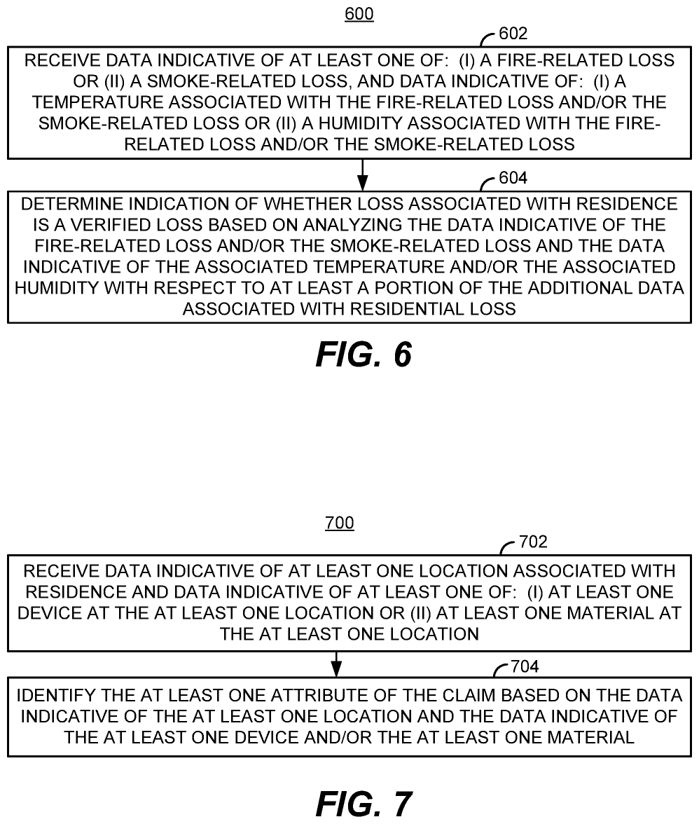

FIG. 3 is a flow chart of an example method, routine, or process 300 for processing a claim for a loss associated with a residence, such as the residence 102. One or more processors of the loss verification subsystem 108, such as a microprocessor implemented in the manner described with respect to the microprocessor 206, may receive data associated with the residence 102, where the data associated with the residence 102 is indicative of a loss associated with the residence 102 and includes data from at least one monitoring device (e.g., one of the devices 114-122) associated with the residence 102 (block 302). Examples of receiving data from at least one of the monitoring devices 114-122, and examples of how different types of data from the different types of monitoring devices 114-122 may ultimately be used in verifying a loss, are further described below with reference to, for example, FIGS. 5 and 6.

The one or more processors of the loss verification subsystem 108 may analyze the data associated with the residence 102 with respect to additional data associated with residential loss (block 304). As noted above, the additional data associated with residential loss may be provided by a party that facilitates a determination of whether the loss associated with the residence 102 is a verified loss (e.g., an insured party associated with the residence 102 such as a homeowner or renter; an insurance provider that insures the residence 102 with respect to the loss indicated by the aforementioned received data associated with the residence 102; a manufacturer, distributor, reseller, etc. of one or more devices such as one or more of the devices 114-122; etc.). The analyzing described with respect to block 304 may include, for example, the one or more processors comparing the data associated with the residence 102 to the additional data associated with residential loss, or to portions of the additional data associated with residential loss.

As further noted above, the additional data provided by the party that facilitates the determination of whether the loss associated with the residence 102 is a verified loss may include data indicating one or more conditions for the data associated with the residence 102 to be indicative of a verified loss associated with the residence 102. As one example, the additional data may indicate one or more combinations of water data device (e.g., flood sensor) 114 and temperature data device (e.g., temperature sensor) 116 outputs that indicate a verified loss due to flooding. As another example, the additional data may indicate one or more combinations of fire and/or smoke data device (e.g., fire alarm and/or smoke detector, etc.) 120, temperature data device 116, and humidity data device (e.g., humidity sensor) 122 outputs that indicate a verified loss due to fire and/or smoke damage. In some examples, the additional data may indicate when one or more outputs of the burglary alarm device (and/or home security system, for example) 118 indicate a verified loss. For example, the additional data may indicate that a threshold degree of motion (e.g., as indicated by a motion sensor(s) of the burglary alarm device 118) and, if desired, data indicating that no authorized occupants of the residence 102 are present in the residence 102, together indicate a verified unauthorized entry into the residence 102. Data indicating that no authorized occupants are present in the residence 102 may be generated based on, for example, cameras in the residence 102 (not shown as such) and data from an insured party that identifies the authorized occupants. It will be appreciated in light of the teaching and disclosure herein that the above examples of additional data associated with residential loss are not limiting, as describing every possible type of such additional data and every possible type of monitoring device(s) or other device(s) or system(s) that could be used to determine an indication of whether a loss is a verified loss would be impractical, if not impossible.

The one or more processors of the loss verification subsystem 108 may determine an indication of whether the loss associated with the residence 102 is a verified loss associated with the residence 102, e.g., a loss for which a claim should be processed, based on the analyzing of the data associated with the residence 102 with respect to the additional data associated with residential loss (block 306). For example, if the data associated with the residence 102 meets at least one condition indicated by the additional data associated with residential loss, it may be determined that the loss is a verified loss. Additionally, in some embodiments, comparison of the data associated with the residence 102 to the additional data, as described with respect to block 304, may result in the presently described determination indicating, for example, a degree or severity of a verified loss. Such an indicated degree or severity may, for example, be used as an attribute of a claim for the loss. Processing a claim for the loss associated with the residence 102, including processing a claim for the loss based on an attribute of the claim, is further described below.

If the determined indication described with respect to block 306 indicates that the loss is a verified loss, the one or more processors of the loss verification subsystem 108 may also send, via the computer network 104, the indication of the loss associated with the residence 102 to the claim processing subsystem 110 of the example residential claim system 100 (block 308). More particularly, the indication that the loss associated with the residence 102 is a verified loss may be sent to the claim processing subsystem 110 so as to cause the claim processing subsystem 110 to process the claim for the loss associated with the residence 102 based on at least one attribute of the claim. The at least one attribute of the claim for the loss associated with the residence 102 may be identified based on at least one of the data associated with the residence 102 or based on further data. For example, as discussed above, the at least one attribute of the claim for the loss may include a degree or severity of the loss, and processing of the claim may thus be based on the at least one attribute by, for example, using the at least one attribute to determine an amount of covered loss with respect to the claim and/or to determine procedures for the insurance provider to cover the loss (e.g., facilitate repairs to the residence 102 and/or replacement of personal property in the residence 102, etc.). Example implementations of claim processing, and additional details regarding identifying an attribute of a claim, are further described below.

If, on the other hand, the determined indication described with respect to block 306 indicates that the loss is not a verified loss, the example method, routine, or process 300 may end (block 310). The example method, routine, or process 300, and other example methods, routines, or processes described herein, may be repeated as needed or desired, such as when additional data associated with the residence 102 and indicative of a loss is received, in the example of FIG. 3.

As will be apparent from the above description, and as should be appreciated with respect to all examples presented in this disclosure, various ones of the functions or operations shown in FIG. 3 are optional. Furthermore, the functions or operations shown in FIG. 3 (and each flow chart herein) may be performed in any suitable order, any desired number of times, and/or with any suitable variation to the particular order and/or combination shown so as to achieve a desired result, such as a desired manner of processing a claim for a loss associated with a residence (e.g., the residence 102).

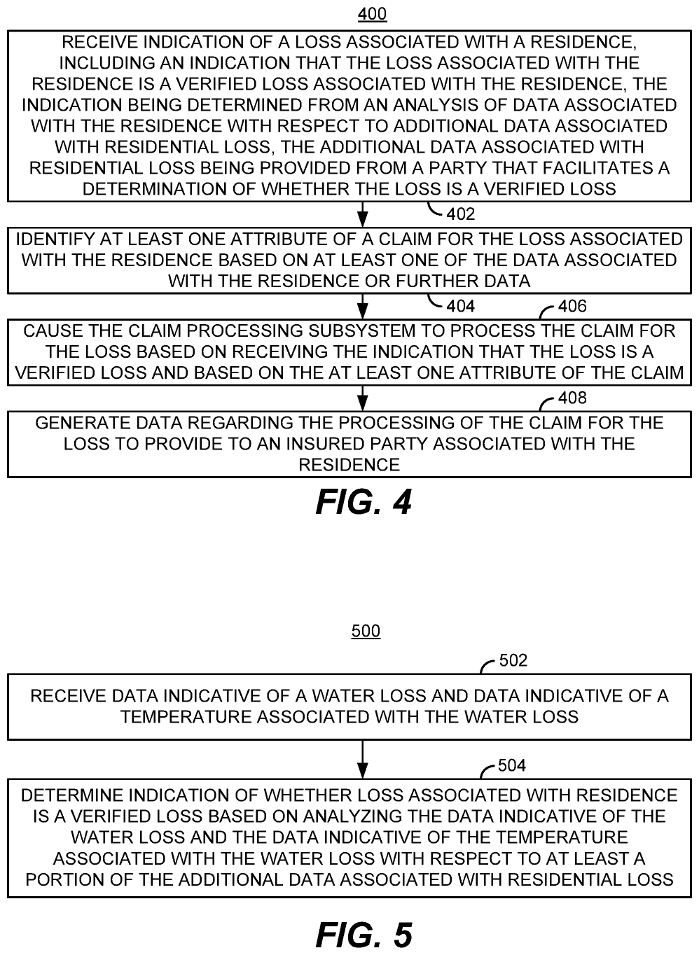

FIG. 4 is another flow chart of another example method, routine, or process 400 for processing a claim for a loss associated with a residence, such as the residence 102, shown from the perspective of the claim processing subsystem 110. One or more processors of the claim processing subsystem 110, such as a microprocessor implemented in the manner described with respect to the microprocessor 206 of FIG. 2, may receive an indication of the loss associated with the residence 102 via the computer network 104 (block 402). The received indication may include an indication from the loss verification subsystem 108 that the loss associated with the residence 102 is a verified loss, with the indication that the loss is a verified loss being determined, for example, from an analysis by the loss verification subsystem 108 of data associated with the residence 102 with respect to additional data associated with residential loss, as described with respect to FIG. 3.

The one or more processors of the claim processing subsystem 110 may identify at least one attribute of the claim for the loss associated with the residence 102 based on at least one of the data associated with the residence 102 or further data (block 404). Example implementations of the actions described with respect to block 404 are further described below.

The one or more processors of the claim processing subsystem 110 may also cause the claim processing subsystem 110 to process the claim for the loss associated with the residence 102 based on receiving the indication from the loss verification subsystem 108 that the loss associated with the residence 102 is a verified loss, and based on the at least one attribute of the claim for the loss associated with the residence 102 (block 406). Example uses of at least one attribute of a claim in processing the claim are further described herein, such as, for example, with respect to FIG. 7.

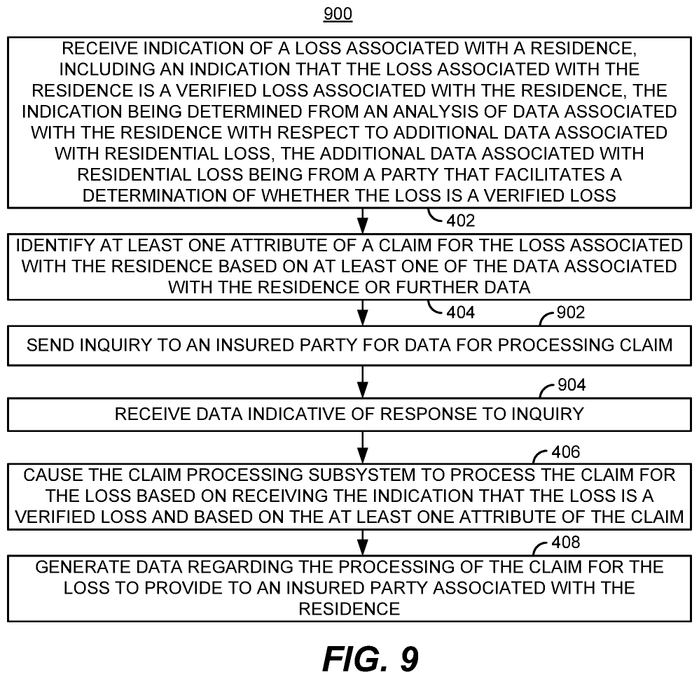

Additionally, the one or more processors of the claim processing subsystem 110 may generate data regarding the processing of the claim for the loss associated with the residence 102 to provide, via the computer network 104, to the residence 102 and/or the remote computing device 106 (block 408). Thus, such data may be provided to an insured party associated with the residence 102 (e.g., a homeowner physically located within the residence 102, by way of the illustrated two-way communication link between the computer network 104 and the residence 102, or using the remote computing device 106). Such data may include, for example, data indicating a result of claim processing, such as a deductible amount owed by the insured party, an amount of loss covered by the insurance provider, and details regarding how the insurance provider will cover that amount of loss. The data generated as described with respect to block 408 may also or alternatively include an inquiry to send to the insured party requesting data for use in processing the claim, as further described below with respect to FIG. 9.

### V. Example Methods for Receiving Data Associated with a Residence and Determining Verified Loss

FIG. 5 is a flow chart of an example method, routine, or process 500 for determining an indication of whether a loss associated with the residence 102 is a verified loss. The loss associated with the residence 102 may be indicated by the data associated with the residence 102, as described above. More particularly, in the example of FIG. 5, the loss may be a water loss, such as a loss related to flooding, surface water, backed-up water, a burst pipe, etc. The example method, routine, or process 500 may be performed using the one or more processors of the loss verification subsystem 108 of the example residential claim system 100 of FIG. 1.

Using the one or more processors, data indicative of a water loss associated with the residence 102 and data indicative of a temperature associated with the water loss may be received (block 502). For example, the data indicative of the water loss may be received from the water data device 114 and the data indicative of the temperature associated with the water loss may be received from the temperature data device 116. The temperature data device 116 may provide the data indicative of the temperature associated with the water loss by virtue of the temperature data device 116 being in physical proximity to the location of the water loss. It will be understood from the teaching and disclosure herein that the actions described with respect to block 502 may be used in implementing the actions described with respect to, for example, block 302 of the example method, routine, or process 300.

An indication of whether the loss associated with the residence 102 is a verified loss associated with the residence 102 may then be determined based on analyzing, using the one or more processors, the data indicative of the water loss and the data indicative of the temperature associated with the water loss with respect to at least a portion of the additional data associated with residential loss (block 504). It will be understood from the teaching and disclosure herein that the actions described with respect to block 504 may be used in implementing the actions described with respect to, for example, block 306 of the example method, routine, or process 300. It will thus be understood that in addition to the actions described with respect to block 504, operation of the example residential claim system 100 may continue as described with respect to, for example, block 308 or block 310.

As discussed with respect to FIG. 3, the determination of the indication of whether the loss associated with the residence 102 is a verified loss may result in an indication of a degree or severity of a verified loss. As one particular example, if the presently described determination indicates that the water loss is a verified loss, the presently described determination may also indicate an increased severity of the water loss by indicating, for example, that the temperature associated with the water loss is less than 35 degrees Fahrenheit. The temperature, or such an indication of increased severity, may be used as an attribute of the claim for the loss during processing of the claim as described with respect to, for example, block 308 of the example method, routine, or process 300.

FIG. 6 is a flow chart of an example method, routine, or process 600 for determining an indication of whether a loss associated with the residence 102 is a verified loss. The loss associated with the residence 102 may be indicated by the data associated with the residence 102, as described above. More particularly, in the example of FIG. 6, the loss may be a fire-related loss and/or a smoke-related loss, such as fire and/or smoke damage, etc. The example method, routine, or process 600 may be performed using the one or more processors of the loss verification subsystem 108 of the example residential claim system 100 of FIG. 1.

Using the one or more processors, data indicative of at least one of (i) a fire-related loss associated with the residence 102 or (ii) a smoke-related loss associated with the residence 102 may be received, and data indicative of at least one of (i) a temperature associated with the at least one of the fire-related loss or the smoke-related loss or (ii) a humidity associated with the at least one of the fire-related loss or the smoke-related loss may also be received (block 602). For example, the data indicative of the at least one of the fire-related loss or the smoke-related loss may be received from the fire and/or smoke data device 120, and the data indicative of the at least one of the associated temperature or the associated humidity may be received from the temperature data device 116 and/or the humidity data device 122.

The temperature data device 116 and/or the humidity data device 122 may provide the data indicative of the associated temperature and/or associated humidity by virtue of being in physical proximity to the location of the at least one of the fire-related loss or the smoke-related loss. Because more than one of each of the example monitoring devices 114-122 of FIG. 1 may be implemented, the residence 102 may include multiple ones of the temperature data device 116 and/or the humidity data device 122. The multiple ones of the temperature data device 116 and/or the humidity data device 122 may in turn provide data indicative of more than one associated temperature and/or more than one associated humidity by virtue of being in physical proximity to more than one location of fire-related loss and/or smoke-related loss. As with the actions described with respect to block 502 of FIG. 5, it will be understood from the teaching and disclosure herein that the actions described with respect to block 602 may be used in implementing the actions described with respect to, for example, block 302 of the example method, routine, or process 300.

An indication of whether the loss associated with the residence 102 is a verified loss associated with the residence 102 may then be determined based on analyzing, using the one or more processors, the data indicative of the fire-related loss and/or smoke-related loss and the data indicative of the associated temperature and/or the associated humidity with respect to at least a portion of the additional data associated with residential loss (block 604). It will be understood from the teaching and disclosure herein that the actions described with respect to block 604 may be used in implementing the actions described with respect to, for example, block 306 of the example method, routine, or process 300. It will thus be understood that in addition to the actions described with respect to block 604, operation of the example residential claim system 100 may continue as described with respect to, for example, block 308 or block 310.

In one embodiment, the presently described indication of whether the loss is a verified loss may be determined based on, for example, whether the temperature associated with a smoke-related loss is above a threshold. Such a determination may assist in avoiding “false alarms” due to activities such as cooking that may cause the fire and/or smoke data device 120 to indicate an alarm (e.g., indicate a loss) when there is not actual smoke-related loss. In another embodiment, the humidity associated with the smoke-related loss may also be used to determine that the smoke-related loss indicated by the data received (e.g., as described with respect to block 602) is a verified loss The associated temperature and/or humidity may also be used as an attribute of the claim for the loss during processing of the claim as described with respect to, for example, block 308 of the example method, routine, or process 300.

It will be appreciated from the teaching and disclosure herein that the example residential claim system 100 allows implementation of numerous other methods, routines, or processes for determining an indication of whether a loss associated with a residence, such as the residence 102, is a verified loss. As just one additional example, data indicative of a burglary-related loss associated with the residence 102 may be received, using the one or more processors of the loss verification subsystem 108 via the computer network 104, from the burglary alarm device (and/or home security system, for example) 118. Data indicative of, for example, a degree of motion and/or data indicative of whether any authorized occupants of the residence 102 are present in the residence 102, as described above, may also be received as data associated with the indicated burglary-related loss. An indication of whether the burglary-related loss is a verified loss may then be determined based on analyzing, using the one or more processors, the aforementioned data or suitable portions thereof. For example, the indication of whether the burglary-related loss is a verified loss may be determined based on an analysis of whether the indicated degree of motion exceeds a threshold degree of motion (e.g., so as to prevent motion of pets in the residence 102, or motion otherwise not attributable to an intruder, from indicating a verified loss) and/or whether any authorized occupants of the residence 102 are determined to be present in the residence 102.

In some embodiments, the data indicative of the burglary-related loss associated with the residence 102 may be received at the remote computing device 106 via the computer network 104. For example, images and/or a video feed generated using one or more cameras of the burglary alarm device (and/or home security system, for example) 118 may be received using one or more processors of the remote computing device 106, and may be presented to a user of the remote computing device 106. The user may be, for example, an insured party associated with the residence 102 (e.g., homeowner) or another party associated with the residence 102 (e.g., a member of a business that provides professional home monitoring services such as monitoring of indications of burglary). The images and/or video feed may be provided to the user of the remote computing device 106 via a user interface thereof, such as via an I/O circuit implemented in the same or a similar manner as the I/O circuit 210 of the controller 202 of the example computing device 200. The user may then provide, via the user interface, one or more inputs indicative of whether the burglary-related loss is a verified loss based on the user's viewing of the images and/or video feed. In this manner, the user (e.g., insured party) may be the party that provides the additional data associated with residential loss, and may be the party that facilitates the determination of whether the loss associated with the residence 102 is a verified loss.

### VI. Example Method for Using Data Indicative of Device and/or Material at a Location in Residence

FIG. 7 is a flow chart of an example method, routine, or process 700 for using data indicative of a device and/or material at a location in the residence 102 in processing a claim for loss. The method, routine, or process 700 may be performed using the one or more processors of the claim processing subsystem 110 of the example residential claim system 100 of FIG. 1.

With reference to the discussion of the example residential claim system 100, the device and/or material data source 124 may be included in or near (e.g., on a porch, in a garage, etc.) the residence 102, and may provide data indicative of at least one location in or otherwise associated with (e.g., on the porch, in the garage, etc.) the residence 102. The device and/or material data source 124 may also provide data indicative of at least one device and/or at least one material at the at least one location, as further noted above. In some embodiments, the data provided by the device and/or material data source 124 may be input to the device and/or material data source 124 by, for example, an insured party associated with the residence 102 (e.g., homeowner).

Using the one or more processors of the claim processing subsystem 110, the data indicative of the at least one location and the data indicative of the at least one device and/or at least one material at the at least one location may be received via the computer network 104 (block 702). This received data may be included in the data associated with the residence 102 and thus may be received by the claim processing subsystem 110 before, after, or concurrently with being received by the loss verification subsystem 108, in some embodiments. In other embodiments, the received data described with respect to block 702 may be further data (e.g., as described with respect to blocks 308 and 404) that is received by the claim processing subsystem 110 separately from the receipt by the one or more processors of the loss verification subsystem 108 of the data associated with the residence 102.

Additionally, with further reference to the discussion above, in some embodiments the device and/or material data source 124 may not be included in or near the residence 102. For example, the device and/or material data source 124 may be remote from the residence 102 and not associated with (e.g., on the porch, in the garage, etc.) the residence 102. In such an example, the device and/or material data source 124 may still provide the data indicative of the at least one location associated with the residence 102 and the data indicative of the at least one device and/or the at least one material at the at least one location via the computer network 104 in order for such data to be received as described with respect to block 702.

In still other embodiments, the data that would be provided by the device and/or material data source 124 may have already been received by the insurance provider (e.g., at the claim processing subsystem 110 or the database 112, as discussed above), and the previous receipt of such data by the insurance provider may constitute the performance of the operations described with respect to block 702. The data that would be provided by the device and/or material data source 124 may alternatively have already been received at the remote computing device 106, such as by way of user input and storage in, for example, a program memory of the remote computing device 106. Such data received at the remote computing device 106 may then be received, using the one or more processors of the claim processing subsystem 110, via the computer network 104 in order to perform the operations described with respect to block 702. In embodiments where the data that would be provided by the device and/or material data source 124 has already been received, the device and/or material data source 124 need not be implemented.

In any event, the at least one attribute of the claim for the loss associated with the residence 102 may be identified based on the data indicative of the at least one location associated with the residence 102 and the data indicative of the at least one device and/or the at least one material at the at least one location (block 704). As discussed above, identification of an attribute or attributes of the claim for the loss in this manner allows an inventory of the residence 102 to be provided to the degree to which data from the device and/or material data source 124 is available. In particular, the inventory of the residence 102 may be provided based on such indicated devices and/or materials and the location(s) associated with the residence 102 at which such indicated devices and/or materials are indicated to be present. Thus, the at least one attribute may indicate items of personal property (which may be classified as devices in view of the foregoing discussion) at particular locations, and/or may indicate types of building materials used in the construction of the residence 102 (which may be classified as materials in view of the foregoing discussion) at particular locations. The claim may then be processed based on the at least one attribute (as described with respect to, for example, block 406) using, for example, a loss estimator that estimates loss based on the provided inventory. The loss estimator may be implemented in hardware, as executable instructions stored in, for example, a program memory of the claim processing subsystem 110, or in any suitable manner.

It will be appreciated from the teaching and disclosure herein that the example method, routine, or process 700 may be used in implementing, for example, the actions described with respect to block 404 of the example method, routine, or process 400.

### VII. Example Method for Enhanced Verification of Loss

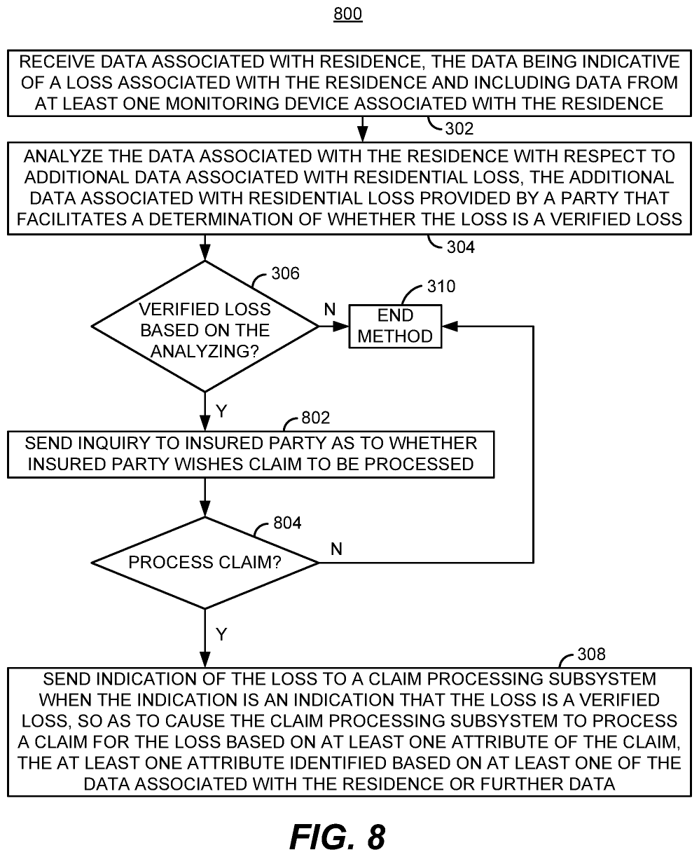

FIG. 8 is a flow chart of an example method, routine, or process 800 for enhanced verification of loss, shown from the perspective of the loss verification subsystem 108. Using one or more processors of the loss verification subsystem 108, the actions described above with respect to blocks 302, 304, and 306 may be performed. As in the example method, routine, or process 300 of FIG. 3, if the indication determined as described with respect to block 306 indicates that the loss associated with the residence 102 is not a verified loss, the method may end (block 310). However, in the example method, routine, or process 800 of FIG. 8, if the indication determined as described with respect to block 306 indicates that the loss associated with the residence 102 is a verified loss, an inquiry may be sent, using the one or more processors, to an insured party associated with the residence 102 as to whether the insured party wishes the claim to be processed (block 802). Sending the inquiry to the insured party may include sending the inquiry to a computing device inside the residence 102 (not shown), to the remote computing device 106, or to the insured party in any other suitable manner.

For example, the inquiry may provide the insured party the opportunity to decline to have the claim for the loss processed, even though the loss has been determined with respect to block 306 to be a verified loss, if the loss is for an amount less than the insured party's deductible, if the insured party is able and willing to repair the loss itself, if the insured party does not want to incur an increase in premium that would result from processing the claim and would prefer to pay for professional repair itself, etc. On the other hand, in some embodiments, even if the loss is for an amount less than the insured party's deductible or will otherwise not cause the deductible to be met, the inquiry described with respect to block 802 may still be sent so as to provide the insured party the opportunity to choose to have the claim processed and thus come closer to meeting its deductible, even though the insured party may still bear costs of repairs until its deductible is met.

It may be determined, using the one or more processors, whether the insured party wishes the claim to be processed (block 804) based on receiving, using the one or more processors, a response to the inquiry. If the insured party does not wish the claim to be processed, the method may end (block 310). If the insured party does wish the claim to be processed, the method may continue by performance of the actions described with respect to block 308 of FIG. 3. In this manner, determining an indication of whether the loss associated with the residence 102 is a verified loss may effectively be further based on the response from the insured party to the aforementioned inquiry.

In other embodiments, the inquiry may be generated and sent by one or more processors of the claim processing subsystem 110 and thus may be sent as part of a modification to the example method, routine, or process 400 of FIG. 4. For example, after performing the actions described with respect to block 404, the sending of the inquiry described with respect to block 802 may be performed, and the determination described with respect to block 804 may be performed. In this example, the modified version of the example method, routine, or process 400 would then end if the determination described with respect to block 804 is negative, in a similar manner as shown and described with respect to FIG. 8. If the determination described with respect to block 804 is positive, on the other hand, then the modified version of the example method, routine, or process 400 may resume with performance of the actions described with respect to block 406.

### VIII. Example Method for Sending Inquiry for Data to Insured Party

FIG. 9 is a flow chart of an example method, routine, or process 900 for sending an inquiry for data to an insured party. Using one or more processors of the claim processing subsystem 110, the actions described above with respect to blocks 402 and 404 may be performed, for example. Additionally, using the one or more processors, an inquiry may be sent to an insured party associated with the residence 102 (e.g., homeowner), the inquiry being an inquiry for data from the insured party for processing the claim for the loss (block 902).

With continued reference to the actions described with respect to block 902, the inquiry sent to the insured party may be, for example, an inquiry for data regarding the residence 102 such as details regarding the extent of loss in the residence 102; details regarding property within the residence 102 that has been damaged; additional personal information of the insured party beyond what may already be on file with the insurance provider; or any other suitable data that may be useful in processing the claim for the loss. As such, the inquiry for data regarding the residence 102 may include an inquiry for data that may also or alternatively be provided by the device and/or material data device 124 in some embodiments, as discussed with respect to, for example, FIG. 7. As just one further example, the inquiry for data regarding the residence 102 may be or may include a request to confirm personal information of the insured party that is already on file. It will be understood in light of the discussion herein that the inquiry for data regarding the residence 102 may be an inquiry for data that is or includes the at least one attribute used in processing the claim for the loss associated with the residence 102.

Sending the inquiry to the insured party may include sending the inquiry to a computing device inside the residence 102 (not shown), to the remote computing device 106, or to the insured party in any other suitable manner. Using the one or more processors of the claim processing subsystem 110, data indicative of a response from the insured party to the inquiry may be received (block 904), such as from the computing device inside the residence 102 or from the remote computing device 106 via the computer network 104, for example. It will be understood from the teaching and disclosure herein that the actions described with respect to blocks 902 and 904 may, for example, be performed concurrently with the actions described with respect to block 406 and/or concurrently with the actions described with respect to block 408. For ease of illustration only, blocks 902 and 904 are shown in FIG. 9 between block 404 and block 406.

In other embodiments, the inquiry may be generated and sent by one or more processors of the loss verification subsystem 108 and thus may be sent as part of a modification to the example method, routine, or process 300 of FIG. 3. For example, the inquiry may be sent as described with respect to block 902 concurrently with performing the actions described with respect to block 406. In just one further example, the inquiry may be sent as described with respect to block 902 concurrently with performing the actions described with respect to block 308, and data indicative of a response may then be received as described with respect to block 904.

As discussed above, it will be appreciated that by providing a system and method for processing a claim for a loss associated with a residence that verifies the loss based on analyzing, for example, data associated with the residence with respect to additional data associated with residential loss provided by a party that facilitates a determination of whether the loss associated with the residence is a verified loss, existing computerized techniques for managing and/or processing claims may be improved. In particular, verifying the loss based on data provided by the party that facilitates the determination of whether the loss is a verified loss, as described herein, fundamentally changes the way in which losses are reported and improves the accuracy of such reporting, thus allowing only legitimate claims to ultimately be processed. Resources of the insurance provider and responding departments such as a police department, fire department, etc. may thus be more effectively deployed.

It will further be appreciated from the teaching and disclosure herein that the described embodiments of a system and a method may be used to replace or improve upon systems and methods for reporting of residential loss as managed by insured parties such as homeowners, professionally-managed reporting of residential loss, and/or processing of insurance claims for residential loss. Such insurance claim processing based on professionally-managed reporting of residential loss that may be improved upon may include, for example, insurance claim processing resulting from professional home monitoring for burglary, as discussed above. More generally, various ones of the embodiments described herein may be used to replace or improve upon any suitable home monitoring, loss reporting, and/or claim processing techniques.

### IX. Additional Considerations

The following additional considerations apply to the foregoing discussion. Throughout this specification, plural instances may implement functions, components, operations, or structures described as a single instance. As noted above, although individual functions and instructions of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The methods described in this application may include one or more functions or routines in the form of non-transitory computer-executable instructions that are stored in a tangible computer-readable storage medium and executed using a processor of a computing device or subsystem or system (e.g., the remote computing device 106, the loss verification subsystem 108, the claim processing subsystem 110, and/or any other computing devices within the example residential claim system 100 in any suitable combination). The routines may be included as part of any of the modules described in relation to FIGS. 1 and 2 or as part of a module that is external to the system illustrated by FIG. 1 and FIG. 2. For example, the methods or portions thereof may be part of a browser application(s) or an application(s) running on the remote computing device 106, the loss verification subsystem 108, and/or the claim processing subsystem 110 as a plug-in or other module of the browser application. Further, the methods may be employed as “software-as-a-service” to provide, for example, the remote computing device 106, the loss verification subsystem 108, and/or the claim processing subsystem 110 with access to the example residential claim system 100.

Additionally, certain aspects are described herein as including logic or a number of functions, components, modules, blocks, or mechanisms. Functions may constitute either software modules (e.g., non-transitory code stored on a tangible machine-readable storage medium) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain functions). A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term hardware should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware and software modules may provide information to, and receive information from, other hardware and/or software modules. Accordingly, the described hardware modules may be regarded as being communicatively coupled. Where multiple of such hardware or software modules exist contemporaneously, communications may be achieved through signal transmission (e.g., over appropriate circuits and buses) that connect the hardware or software modules. In embodiments in which multiple hardware modules or software are configured or instantiated at different times, communications between such hardware or software modules may be achieved, for example, through the storage and retrieval of information in memory structures to which the multiple hardware or software modules have access. For example, one hardware or software module may perform an operation and store the output of that operation in a memory device to which it is communicatively coupled. A further hardware or software module may then, at a later time, access the memory device to retrieve and process the stored output. Hardware and software modules may also initiate communications with input or output devices, and may operate on a resource (e.g., a collection of information).

The various operations of example functions and methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or functions described herein may be at least partially processor-implemented. For example, at least some of the functions of a method may be performed by one or processors or processor-implemented hardware modules. The performance of certain of the functions may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the functions may be performed by a group of computers (as examples of machines including processors), these operations being accessible via a network (e.g., the Internet) and via one or more appropriate interfaces (e.g., application program interfaces (APIs)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Still further, the figures depict preferred embodiments of an example residential claim system 100 and methods for purposes of illustration only. One of ordinary skill in the art will readily recognize from the following discussion that alternative embodiments of the structures and methods illustrated herein may be employed without departing from the principles described herein.

Upon reading this disclosure, those of skill in the art will appreciate still additional alternative structural and functional designs for a system and method for processing a claim for a loss associated with a residence. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

To the extent that any meaning or definition of a term in this document conflicts with any meaning or definition of the same term in a document incorporated by reference, the meaning or definition assigned to that term in this document shall govern. Although the text sets forth a detailed description of numerous different embodiments, it should be understood that the legal scope of the description is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims. While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A computer-implemented method for processing a claim for a loss associated with a residence, the method comprising:
receiving, using one or more processors of a claim processing subsystem of a residential claim system, via a computer network, an indication of the loss associated with the residence, the received indication including a verification from a loss verification subsystem of the residential claim system determined from an analysis by the loss verification subsystem of data associated with the residence with respect to additional data associated with residential loss provided by at least one of an insurance provider that insures the residence with respect to the loss associated with the residence, an insured party associated with the residence, or at least one manufacturer of at least one monitoring device associated with the residence, to facilitate a determination of whether the loss associated with the indication occurred;
identifying, using the one or more processors, at least one attribute of the claim for the loss associated with the residence based on at least one of the data associated with the residence or further data;
causing, using the one or more processors, the claim processing subsystem to process the claim for the loss associated with the residence based on receiving the verification of the indication from the loss verification subsystem;
generating, using the one or more processors, data regarding the processing of the claim for the loss associated with the residence based on the verification of the indication of the loss; and
providing, via the computer network, the generated data regarding the processing of the claim to the insured party associated with the residence.

2. The computer-implemented method of claim 1, wherein the data from the at least one monitoring device associated with the residence includes data indicative of a water loss associated with the residence and data indicative of a temperature associated with the water loss, wherein at least a portion of the additional data associated with residential loss includes data indicating at least one condition for the data indicative of the water loss and the data indicative of the temperature associated with the water loss to be indicative of a verified loss, and wherein receiving the indication of the loss associated with the residence includes receiving, using the one or more processors, the indication that the loss associated with the residence is a verified loss as determined from analyzing the data indicative of the water loss and the data indicative of the temperature associated with the water loss with respect to the at least the portion of the additional data associated with residential loss.

3. The computer-implemented method of claim 1, wherein the data from the at least one monitoring device associated with the residence includes data indicative of at least one of a fire-related loss associated with the residence or a smoke-related loss associated with the residence and data indicative of at least one of (i) a temperature associated with the at least one of the fire-related loss or the smoke-related loss or (ii) a humidity associated with the at least one of the fire-related loss or the smoke-related loss, wherein at least a portion of the additional data associated with residential loss includes data indicating at least one condition for the data indicative of the at least one of the fire-related loss or the smoke-related loss and the data indicative of the at least one of the temperature or the humidity to be indicative of a verified loss, and wherein receiving the indication of the loss associated with the residence includes receiving, using the one or more processors, the indication that the loss associated with the residence is a verified loss as determined from analyzing the data indicative of the at least one of the fire-related loss or the smoke-related loss and the data indicative of the at least one of the temperature or the humidity with respect to the at least the portion of the additional data associated with residential loss.

4. The computer-implemented method of claim 1, wherein the at least one of the data associated with the residence or the further data includes data indicative of at least one location associated with the residence and data indicative of at least one of at least one device at the at least one location or at least one material at the at least one location, the method further comprising:
receiving, using the one more processors via the computer network, the data indicative of the at least one location and the data indicative of the at least one of the at least one device or the at least one material; and
identifying, using the one or more processors, the at least one attribute of the claim for the loss associated with the residence based on the data indicative of the at least one location and the data indicative of the at least one of the at least one device or the at least one material.

5. The computer-implemented method of claim 1, further comprising sending an inquiry to the insured party associated with the residence as to whether the insured party wishes the claim for the loss associated with the residence to be processed, the indication that the loss associated with the residence is a verified loss being determined further based on a response from the insured party to the inquiry.

6. The computer-implemented method of claim 1, further comprising sending an inquiry to the insured party associated with the residence so as to obtain data from the insured party for processing the claim for the loss associated with the residence.

7. The computer-implemented method of claim 1, the claim processing subsystem being operated by the insurance provider that insures the residence with respect to the loss associated with the residence, the loss verification subsystem being operated by a party other than the insurance provider that insures the residence with respect to the loss associated with the residence.

8. A computing system for processing a claim for a loss associated with a residence, the computing system comprising:
one or more processors; and
one or more memories coupled to the one or more processors,
the one or more memories including non-transitory computer executable instructions stored therein that, when executed by the one or more processors, cause the one or more processors to:
receive an indication of the loss associated with the residence, the received indication including a verification from a loss verification subsystem of a residential claim system determined from an analysis by the loss verification subsystem of data associated with the residence with respect to additional data associated with the loss associated with the residential loss provided by at least one of an insurance provider that insures the residence with respect to the loss associated with the residence, an insured party associated with the residence, or at least one manufacturer of at least one monitoring device associated with the residence, to facilitate a determination of whether the loss associated with the indication occurred;
identify at least one attribute of the claim for the loss associated with the residence based on at least one of the data associated with the residence or further data;
cause a claim processing subsystem of the residential claim system to process the claim for the loss associated with the residence based on receiving the verification of the indication from the loss verification subsystem;
generate data regarding the processing of the claim for the loss associated with the residence based on the verification of the indication of the loss; and
provide the generated data regarding the processing of the claim to the insured party associated with the residence.

9. The computing system of claim 8, wherein the data from the at least one monitoring device associated with the residence includes data indicative of a water loss associated with the residence and data indicative of a temperature associated with the water loss, wherein at least a portion of the additional data associated with residential loss includes data indicating at least one condition for the data indicative of the water loss and the data indicative of the temperature associated with the water loss to be indicative of a verified loss, the one or more memories further including non-transitory computer executable instructions that when executed cause the one or more processors to receive the indication of the loss associated with the residence by receiving the indication that the loss associated with the residence is a verified loss as determined from analyzing the data indicative of the water loss and the data indicative of the temperature associated with the water loss with respect to the at least the portion of the additional data associated with residential loss.

10. The computing system of claim 8, wherein the data from the at least one monitoring device associated with the residence includes data indicative of at least one of a fire-related loss associated with the residence or a smoke-related loss associated with the residence and data indicative of at least one of (i) a temperature associated with the at least one of the fire-related loss or the smoke-related loss or (ii) a humidity associated with the at least one of the fire-related loss or the smoke-related loss, wherein at least a portion of the additional data associated with residential loss includes data indicating at least one condition for the data indicative of the at least one of the fire-related loss or the smoke-related loss and the data indicative of the at least one of the temperature or the humidity to be indicative of a verified loss, the one or more memories further including non-transitory computer executable instructions that when executed cause the one or more processors to receive the indication of the loss associated with the residence by receiving the indication that the loss associated with the residence is a verified loss as determined from analyzing the data indicative of the at least one of the fire-related loss or the smoke-related loss and the data indicative of the at least one of the temperature or the humidity with respect to the at least the portion of the additional data associated with residential loss.

11. The computing system of claim 8, wherein the at least one of the data associated with the residence or the further data includes data indicative of at least one location associated with the residence and data indicative of at least one of at least one device at the at least one location or at least one material at the at least one location, the one or more memories further including non-transitory computer executable instructions that when executed cause the one or more processors to:
receive the data indicative of the at least one location and the data indicative of the at least one of the at least one device or the at least one material; and
identify the at least one attribute of the claim for the loss associated with the residence based on the data indicative of the at least one location and the data indicative of the at least one of the at least one device or the at least one material.

12. The computing system of claim 8, the one or more memories further including non-transitory computer executable instructions that when executed cause the one or more processors to send an inquiry to the insured party associated with the residence as to whether the insured party wishes the claim for the loss associated with the residence to be processed, the indication that the loss associated with the residence is a verified loss being determined further based on a response from the insured party to the inquiry.

13. The computing system of claim 8, the one or more memories further including non-transitory computer executable instructions that when executed cause the one or more processors to send an inquiry to the insured party associated with the residence so as to obtain data from the insured party for processing the claim for the loss associated with the residence.

14. The computing system of claim 8, the claim processing subsystem being operated by the insurance provider that insures the residence with respect to the loss associated with the residence, the loss verification subsystem being operated by a party other than the insurance provider that insures the residence with respect to the loss associated with the residence.

15. A computer readable storage medium comprising non-transitory computer readable instructions stored thereon for processing a claim for a loss associated with a residence, wherein the instructions when executed on one or more processors cause the one or more processors to:
receive an indication of the loss associated with the residence, the received indication including a verification from a loss verification subsystem of a residential claim determined from an analysis by the loss verification subsystem of data associated with the residence with respect to additional data associated with the loss associated with the residential loss provided by at least one of an insurance provider that insures the residence with respect to the loss associated with the residence, an insured party associated with the residence, or at least one manufacturer of at least one monitoring device associated with the residence, to facilitate a determination of whether the loss associated with the indication occurred
identify at least one attribute of the claim for the loss associated with the residence based on at least one of the data associated with the residence or further data;
cause a claim processing subsystem of the residential claim system to process the claim for the loss associated with the residence based on receiving the verification of the indication from the loss verification subsystem;
generate data regarding the processing of the claim for the loss associated with the residence based on the verification of the indication of the loss; and
provide the generated data regarding the processing of the claim to the insured party associated with the residence.

16. The computer readable storage medium of claim 15, wherein the data from the at least one monitoring device associated with the residence includes data indicative of a water loss associated with the residence and data indicative of a temperature associated with the water loss, wherein at least a portion of the additional data associated with residential loss includes data indicating at least one condition for the data indicative of the water loss and the data indicative of the temperature associated with the water loss to be indicative of a verified loss, the computer readable storage medium further comprising non-transitory computer readable instructions stored thereon that when executed cause the one or more processors to receive the indication of the loss associated with the residence by receiving the indication that the loss associated with the residence is a verified loss as determined from analyzing the data indicative of the water loss and the data indicative of the temperature associated with the water loss with respect to the at least the portion of the additional data associated with residential loss.

17. The computer readable storage medium of claim 15, wherein the data from the at least one monitoring device associated with the residence includes data indicative of at least one of a fire-related loss associated with the residence or a smoke-related loss associated with the residence and data indicative of at least one of (i) a temperature associated with the at least one of the fire-related loss or the smoke-related loss or (ii) a humidity associated with the at least one of the fire-related loss or the smoke-related loss, wherein at least a portion of the additional data associated with residential loss includes data indicating at least one condition for the data indicative of the at least one of the fire-related loss or the smoke-related loss and the data indicative of the at least one of the temperature or the humidity to be indicative of a verified loss, the computer readable storage medium further comprising non-transitory computer readable instructions stored thereon that when executed cause the one or more processors to receive the indication of the loss associated with the residence by receiving the indication that the loss associated with the residence is a verified loss as determined from analyzing the data indicative of the at least one of the fire-related loss or the smoke-related loss and the data indicative of the at least one of the temperature or the humidity with respect to the at least the portion of the additional data associated with residential loss.

18. The computer readable storage medium of claim 15, wherein the at least one of the data associated with the residence or the further data includes data indicative of at least one location associated with the residence and data indicative of at least one of at least one device at the at least one location or at least one material at the at least one location, the computer readable storage medium further comprising non-transitory computer readable instructions stored thereon that when executed cause the one or more processors to:
receive the data indicative of the at least one location and the data indicative of the at least one of the at least one device or the at least one material; and
identify the at least one attribute of the claim for the loss associated with the residence based on the data indicative of the at least one location and the data indicative of the at least one of the at least one device or the at least one material.

19. The computer readable storage medium of claim 15, the computer readable storage medium further comprising non-transitory computer readable instructions stored thereon that when executed cause the one or more processors to send an inquiry to the insured party associated with the residence as to whether the insured party wishes the claim for the loss associated with the residence to be processed, the indication that the loss associated with the residence is a verified loss being determined further based on a response from the insured party to the inquiry.

20. The computer readable storage medium of claim 15, the computer readable storage medium further comprising non-transitory computer readable instructions stored thereon that when executed cause the one or more processors to send an inquiry to the insured party associated with the residence so as to obtain data from the insured party for processing the claim for the loss associated with the residence.
